(19) United States
(12) Patent Application Publication
(10) Pub. No.: US 2020/0246867 A1
(43) Pub. Date: Aug. 6, 2020

(54) IRON POWDER, METHOD FOR PRODUCING THE SAME, MOLDED BODY FOR INDUCTOR, AND INDUCTOR

(71) Applicant: DOWA ELECTRONICS MATERIALS CO., LTD., Tokyo (JP)

(72) Inventors: Hidenori YAMAJI, Tokyo (JP); Masahiro GOTOH, Tokyo (JP)

(21) Appl. No.: 16/639,800

(22) PCT Filed: Sep. 14, 2018
(86) PCT No.: PCT/JP2018/034106

§ 371 Date: Feb. 18, 2020

(30) Foreign Application Priority Data
Sep. 22, 2017 (JP) 2017-182728

(51) Int. Cl. B22F 1/02; B22F 1/00; B22F 5/00; H01F 1/20; H01F 41/02

(52) U.S. Cl. CPC B22F 1/02; B22F 1/0014; B22F 1/0062; B22F 5/007; B22F 2003/023; H01F 41/0246; B22F 2304/054; B22F 2304/056; H01F 1/20

(57) ABSTRACT

An iron powder with a small complex particle diameter is used for a molded body having a large real part μ′ of the complex relative permeability. A silane compound in an amount of from 0.1 to 0.3 in terms of Si/Fe ratio is added to a slurry containing a hydrated oxide of iron precipitate obtained through neutralization of an acidic aqueous solution containing a trivalent Fe ion with an alkali aqueous solution to coat the precipitate of the hydrated oxide of iron with a hydrolyzate of the silane compound, in which a phosphorus-containing ion in an amount of from 0.003 to 0.1 in terms of P/Fe ratio co-exists in the slurry. The hydrated oxide of iron precipitate after coating is recovered through solid-liquid separation, and then heated to provide iron particles coated with a silicon oxide. The silicon oxide coating is dissolved and removed to provide the iron powder.

### TECHNICAL FIELD

The present invention relates to iron powder that provides a molded body obtained through mixing with a resin and compression molding having a large real part μ′ of the complex relative permeability, and a method for producing the same.

### BACKGROUND ART

Powder of an iron based metal, which is a magnetic material, has been molded as a green compact and used as a magnetic core of an inductor. Examples of the known iron based metal include powder of an iron based alloy, such as an Fe based amorphous alloy containing large amounts of Si and B (PTL 1), an Fe—Si—Al based Sendust, and a permalloy (PTL 2), and carbonyl iron powder (NFL 1). These kinds of iron powder have been formed into a composite with an organic resin and into a molded body, and applied to the production of a surface mounting coil component (PTL 2).

PTL 3 describes, as a production method of an inductor for a high frequency band, a production method of using a mixture of iron based metal powder having a large particle diameter, iron based metal powder having a medium particle diameter, and nickel based metal powder having a small particle diameter. The literature states that the mixing of powder having different particle diameters enhances the packing density, and as a result, the inductance of the inductor can be enhanced.

A power inductor, which is one kind of inductors, is being used in higher frequencies in recent years, and an inductor capable of being used at a high frequency of 100 MHz or more is demanded. For the power inductor of this type used at 100 MHz or more, a molded body (i.e., a metal powder-resin composite) having a high permeability μ′ is demanded. The increased permeability of the molded body can enhance the inductance to decrease the number of turns of wire required for providing the intended inductance, and thereby the inductor can be reduced in size.

The general measure for achieving a high permeability is the mixing of metal powder with a high permeability having different particle diameters, as described in PTL 3. PTL 3 uses nickel based metal powder having a particle diameter of from 60 to 200 nm as the metal powder having a small particle diameter, but even though iron powder is tried to use instead of the nickel based metal powder, only metal powder having a particle diameter approximately of from 0.8 to 1 μm at best is available. In the case where iron powder having a small particle diameter and simultaneously having a permeability that is equivalent to or higher than the ordinary materials can be obtained, it is expected that the permeability of the inductor can be enhanced while suppressing the raw material cost of the metal powder having a smaller particle diameter than PTL 3. Accordingly, there is a demand of iron powder having a small particle diameter and simultaneously having a permeability that is equivalent to or higher than the ordinary materials.

### CITATION LIST

### Patent Literatures

PTL 1: JP-A-2016-014162
PTL 2: JP-A-2014-060284
PTL 3: JP-A-2016-139788
PTL 4: WO 2008/149785
PTL 5: JP-A-60-011300

### Non-Patent Literature

NPL 1: Yuichiro Sugawa et al., 12th MMM/INTERMAG CONFERENCE, CONTRIBUTED PAPER, HU-04, final manuscript.

### SUMMARY OF INVENTION

### Technical Problem

As described above, there are demands of iron powder with high μ′ suitable for the purpose of a power inductor used at 100 MHz or more, and a production method therefor. The general production method of iron powder for the purpose of a power inductor is an atomizing method, but only particles having a large size can be produced thereby. The known methods of metal powder having a small particle size include the production method of magnetic powder used in a coating type magnetic recording medium, such as a videotape, which is obtained through reduction of iron oxide powder produced by the wet method, but the magnetic powder produced by the production method is an acicular crystal having a large aspect ratio (axial ratio), has a major axial length of approximately 0.2 μm, and furthermore has a problem that it is difficult to increase μ′ due to the high magnetic anisotropy thereof. PTL 4 describes a method for producing iron oxide powder having a small aspect ratio by the wet method, but the iron oxide powder obtained by the production method has an average particle diameter of approximately several tens nanometers, and it is expected that iron powder obtained through reduction thereof has low W. PTL 5 describes a technique for providing iron particles in such a manner that oxyhydroxide crystals formed in the presence of phosphate ion are coated with a silicon oxide and then reduced, but in the technique described in PTL 5, the resulting crystals are acicular crystals since the acicular oxyhydroxide is used as seed crystals, and also the details of the silicon oxide coating are unclear.

It has been investigated to produce iron powder having a large average particle diameter by improving the production methods of iron powder by the wet method described above, but metal powder of 0.2 μm or more has been unable to produce.

In view of the aforementioned problems, an object of the present invention is to provide iron powder that has a small particle diameter and provides a molded body obtained through mixing with a resin and compression molding having a large real part μ′ of the complex relative permeability, and a method for producing the same, by controlling the average particle diameter and the average axial ratio of the iron powder and the impurity concentration contained in the metal powder.

### Solution to Problem

For achieving the aforementioned object, the present invention provides iron powder containing iron particles having an average particle diameter of 0.25 μm or more and 0.70 μm or less and an average axial ratio of 1.5 or less, the iron powder having an Si content of 2% by mass or less based on the mass of the iron powder, and the iron powder providing a molded body obtained through mixing of the iron powder and a bisphenol F type epoxy resin at a mass ratio of 9/1 and compression molding having a real part μ′ of a complex relative permeability measured at 100 MHz of 6.8 or more. The iron powder may have a P content of 0.05% by mass or more and 1.0% by mass or less based on the mass of the iron powder.

The present invention also provides a method for producing iron powder containing iron particles having an average particle diameter of 0.25 μm or more and 0.70 μm or less and an average axial ratio of 1.5 or less, the iron powder having an Si content of 2% by mass or less based on the mass of the iron powder, and the iron powder providing a molded body obtained through mixing of the iron powder and a bisphenol F type epoxy resin at a mass ratio of 9/1 and compression molding having a real part μ′ of a complex relative permeability measured at 100 MHz of 6.8 or more.

Specifically, there is provided a method for producing iron powder, including: neutralizing an acidic aqueous solution containing a trivalent Fe ion and a phosphorus-containing ion (described later) in an amount of from 0.003 to 0.1 in terms of a molar ratio of P with respect to a molar number of the trivalent Fe ion (P/Fe ratio), with an alkali aqueous solution to provide a slurry of a precipitate of a hydrated oxide of iron; adding a silane compound in an amount of from 0.1 to 0.3 in terms of a molar ratio of Si with respect to a molar number of Fe contained in the slurry (Si/Fe ratio), to the slurry, so as to coat the precipitate of the hydrated oxide of iron with a hydrolyzate of the silane compound; recovering the precipitate of the hydrated oxide of iron coated with the hydrolyzate of the silane compound, through solid-liquid separation; heating the recovered precipitate of the hydrated oxide of iron coated with the hydrolyzate of the silane compound, so as to provide iron oxide particles coated with a silicon oxide; heating the iron oxide powder coated with a silicon oxide in a reducing atmosphere, so as to reduce the iron oxide powder coated with a silicon oxide to iron powder coated with the silicon oxide; and immersing the iron powder coated with the silicon oxide in an alkali aqueous solution to dissolve the silicon oxide coating, so as to regulate an Si amount contained in the iron powder to 2% by mass or less.

In the production method of iron powder, it is possible that the phosphorus-containing ion is added to the slurry of the hydrated oxide of iron after the formation of the precipitate of the hydrated oxide of iron, and thereafter the hydrolyzate of the silane compound is coated in an amount of from 0.1 to 0.3 in terms of the molar ratio of Si with respect to the molar number of Fe contained in the slurry (Si/Fe ratio). It is also possible that the phosphorus-containing ion is added after the formation of the precipitate of the hydrated oxide of iron, and during a period of from the start of addition of the silane compound to the completion of the addition thereof in coating the hydrolyzate of the silane compound in an amount of from 0.1 to 0.3 in terms of the molar ratio of Si with respect to the molar number of Fe contained in the slurry (Si/Fe ratio).

The present invention also provides a molded body for an inductor, containing the aforementioned iron powder or the aforementioned iron powder coated with the silicon oxide, which has been molded, and an inductor.

### Advantageous Effects of Invention

The use of the production method of the present invention enables the production of iron powder that has a small particle diameter and provides a molded body obtained through mixing with a resin and compression molding having a large real part μ′ of the complex relative permeability.

### BRIEF DESCRIPTION OF DRAWING

FIG. 1 is a micrograph of a scanning electron microscope (SEM) of the iron powder obtained in Example 1.

### DESCRIPTION OF EMBODIMENTS

For the production of iron powder as a magnetic material, the present invention uses the method, in which according to the wet method excellent in productivity, a precipitate of a hydrated oxide of iron obtained through neutralization of an acidic aqueous solution containing a trivalent Fe ion with an alkali is heated and dehydrated to produce iron oxide powder as a precursor, and the iron oxide powder is reduced to provide the target iron powder. The production of atomized powder requires a high pressure equipment, such as a compressor, for generating a high speed gas flow or liquid flow. The production of carbonyl iron powder requires a large-scale equipment for performing distillation and evaporation of carbonyl iron. However, the wet method does not require the large-scale equipment as in the production apparatus for the atomized powder and carbonyl iron powder.

The particle diameter distribution of the iron powder obtained by the wet method can be uniformized to a certain extent in such a manner that a silane compound is added to the slurry containing the precipitate of the hydrated oxide of iron formed through the neutralization reaction of an Fe ion, the silane compound is subjected to hydrolysis reaction, and the precipitate of the hydrated oxide of iron is coated with the hydrolyzate, followed by heating, but a method of controlling the particle diameter itself of the iron powder finally obtained to a desired value has not yet been known.

The silicon oxide coating itself covers the surface of the iron powder even after the iron oxide powder is reduced to the iron powder. Accordingly, for the purpose of the use of iron powder having an insulating coating, such as the purpose of the use of a molded body of compressed powder of the iron powder as a magnetic core, the silicon oxide coating can be used directly as the insulating coating, but in the case where no insulating coating is required, the iron oxide powder is reduced to iron powder, which is then used after removing the silicon oxide coating.

The hydrolyzate of the silane compound covering the precipitate of the hydrated oxide of iron is changed to the silicon oxide through dehydration condensation by the subsequent heating treatment, but depending on the heating condition, there are cases where the hydrolyzate is not changed to silicon oxide (SiO₂) having the stoichiometric composition, but the OH group forming the hydrolyzate of the silane compound partially remains, and the organic group derived from the silane compound partially remains. In the present invention, the materials having the OH group or the organic group partially remaining, the materials containing a phosphorus-containing ion derived from the reaction solution, and the like are generically referred to as the silicon oxide.

As a result of the detailed studies by the present inventors, it has been found that the average particle diameter of the iron oxide particles in the iron oxide powder coated with the silicon oxide can be controlled, and consequently the average particle diameter of the iron particles can be controlled, in such a manner that the silane compound is added to the slurry containing the precipitate of the hydrated oxide of iron, the silane compound is subjected to hydrolysis reaction, and the precipitate of the hydrated oxide of iron is coated with the hydrolyzate, in which a phosphorus-containing ion is made to co-exist in the slurry.

Examples of the embodiments of the co-existence of the phosphorus-containing ion include the following. In a first embodiment, the phosphorus-containing ion is added to the acidic aqueous solution containing a trivalent Fe ion as a starting substance of the reaction, and the solution is neutralized with an alkali to form the precipitate of the hydrated oxide of iron, resulting in a slurry, to which the silane compound is added. In a second embodiment, the acidic aqueous solution containing a trivalent Fe ion is neutralized with an alkali to form the precipitate of the hydrated oxide of iron, and then the phosphorus-containing ion is added to the slurry containing the precipitate. In a third embodiment, the phosphorus-containing ion is added along with the silane compound during coating the precipitate of the hydrated oxide of iron with the silane compound, thereby making the phosphorus-containing ion to co-exist. In the production method of the present invention, any of the aforementioned methods may be used as the method of making the phosphorus-containing ion to co-exist in the slurry, in coating the precipitate of the hydrated oxide or iron with the hydrolyzate of the silane compound.

By performing the heat treatment after coating the precipitate of the hydrated oxide of iron formed under the co-existence of the phosphorous-containing ion with the hydrolyzate of the silane compound, or after coating the precipitate of the hydrated oxide of iron with the silane compound while adding the phosphorus-containing ion during the addition of the silane compound, the iron oxide powder coated with the silicon oxide containing iron oxide powder that has larger average particle diameter and a smaller average axial ratio than the case without the co-existence of the phosphorus-containing ion can be obtained, and by reducing the iron oxide powder coated with the silicon oxide, the iron powder coated with the silicon oxide that has larger average particle diameter and a smaller average axial ratio can be finally obtained. By removing the silicon oxide coating, the iron powder having no coated layer can be obtained.

The mechanism of the increase of the average particle diameter of the iron oxide after the heat treatment by performing the heat treatment after coating the precipitate of the hydrated oxide of iron with the hydrolyzate of the silane compound under the co-existence of the phosphorus-containing ion is not currently clear, and it is considered that one of the factors is the change of the property of the silicon oxide coating through the reaction of the silicon oxide and the phosphorus-containing ion. Other factors are also considered that, for example, the phosphorus-containing ion is adsorbed to the surface of the precipitate to change the isoelectric point thereof, which changes the aggregated state of the precipitate. The present invention has been completed based on the aforementioned knowledge relating the addition of the phosphorus-containing ion.

[Iron Particles]

The magnetic iron particles constituting the iron powder obtained by the present invention are particles of substantially pure iron except for the impurities that are unavoidably mixed due to the production process thereof.

The iron particles preferably have an average particle diameter of 0.25 μm or more and 0.70 μm or less and an average axial ratio of 1.5 or less.

The average particle diameter that is less than 0.25 μm is not preferred since μ′ of the composite described above may be small. The average particle diameter that exceeds 0.70 μm is not preferred since the enhancement of the packing density of the metal powder in an inductor by using a mixture of metal powder having a large particle diameter and a medium particle diameter as described in the related art may not be achieved. The average particle diameter is more preferably 0.30 μm or more and 0.65 μm or less, the average particle diameter is further preferably 0.35 μm or more and 0.65 μm or less, and the average particle diameter is still further preferably 0.40 μm or more and 0.60 μm or less. The average axial ratio that exceeds 1.5 is not preferred since μ′ may be decreased due to the increase of the magnetic anisotropy. The lower limit of the axial ratio may not be particularly determined, and the iron particles having an axial ratio of 1.2 or more may be generally obtained. The coefficient of variation of the axial ratio may be, for example, 0.1 or more and 0.3 or less.

The iron particles can be obtained by dissolving and removing the silicon oxide coating of the iron powder coated with the silicon oxide in an alkali aqueous solution. At this time, the complete removal of the silicon oxide coating requires a considerably prolonged reaction time, and therefore the reaction may be terminated in a state that the silicon oxide coating partially remains, from the standpoint of the production cost in the industrial process.

Accordingly, the iron powder of the present invention may contain a small amount of Si as an impurity.

As a result of the detailed studies by the present inventors, it has been found that there is a tendency that μ′ of the composite is decreased when the iron powder contains Si. The mechanism thereof may be that μ′ of the iron powder is decreased by increasing the content of Si since Si is a non-magnetic component. Accordingly, the Si amount contained in the iron powder is preferably 2% by mass or less based on the mass of the iron powder. The lower limit of the Si amount contained in the iron powder may not be particularly limited in the present invention, and may be the lower detection limit or less.

In the production method of the present invention, for controlling the shape of the iron particles, a phosphorus-containing ion is made to co-exist in coating the precipitate of the hydrated oxide of iron as a precursor with the hydrolyzate of the silane compound. Accordingly, the iron powder obtained by the production method of the present invention contains P as an unavoidable impurity. P also has a function decreasing μ′ of the composite as similar to Si. Accordingly, in the iron powder of the present invention, the P content contained in the powder is preferably 0.05% by mass or more and 1.0% by mass or less based on the mass of the iron powder. The P content is more preferably 0.05% by mass or more and 0.32% by mass or less, and further preferably 0.05% by mass or more and 0.23% by mass or less.

The content of iron in the iron powder of the present invention may be, for example, 75% by mass or more and 97% by mass or less based on the mass of the iron powder.

In the present invention, a molded body obtained through mixing of the iron powder and a bisphenol F type epoxy resin at a mass ratio of 9/1 and compression molding preferably has a real part μ′ of a complex relative permeability measured at 100 MHz of 6.8 or more. μ′ that is less than 6.8 is not preferred since the miniaturization effect of an electronic component represented by an inductor may be decreased. In the present invention, the upper limit of μ′ may not be particularly determined.

[Starting Substance]

In the production method of the present invention, an acidic aqueous solution containing a trivalent Fe ion (which may be hereinafter referred to as a raw material solution) is used as a starting substance of the iron oxide powder coated with the silicon oxide as the precursor. In the case where a divalent Fe ion is used as the starting substance instead of a trivalent Fe ion, a mixture containing a hydrated oxide of the divalent iron, magnetite, and the like, in addition to the hydrated oxide of the trivalent Fe is formed as a precipitate, which may cause variation in shape of the iron particles finally obtained, failing to provide the iron powder and the iron powder coated with the silicon oxide as in the present invention. The term acidic herein means pH of the solution of less than 7. The supply source of the Fe ion is preferably a water soluble inorganic acid salt, such as a nitrate, a sulfate, and a chloride from the standpoint of the availability and the cost. By dissolving the Fe salt in water, the aqueous solution exhibits acidity through hydrolysis of the Fe ion. By neutralizing the acidic aqueous solution containing the Fe ion by adding an alkali thereto, the precipitate of the hydrated oxide of iron is obtained. The hydrated oxide of iron herein is a substance represented by the general formula Fe₂O₃.nH₂O, and is FeOOH (iron oxyhydroxide) when n=1, or Fe(OH)₃ (iron hydroxide) when n=3.

The Fe ion concentration in the raw material solution is not particularly determined in the present invention, and is preferably 0.01 mol/L or more and 1 mol/L or less. The concentration of less than 0.01 mol/L is not economically preferred since the amount of the precipitate obtained through single reaction is small. The Fe ion concentration that exceeds 1 mol/L is not preferred since the reaction solution tends to gel through the rapid formation of a precipitate of the hydrated oxide.

[Neutralization Treatment]

In the first embodiment of the production method of the present invention, an alkali is added to the raw material solution containing the phosphorus-containing ion described later in an amount of from 0.003 to 0.1 in terms of the molar ratio of P with respect to the molar number of the trivalent Fe ion (P/Fe ratio) under agitation with a known mechanical means, so as to neutralize the solution to make the pH thereof of 7 or more and 13 or less, thereby forming the precipitate of the hydrated oxide of iron. The pH after the neutralization that is less than 7 is not preferred since the Fe ion is not precipitated in the form of the hydrated oxide of iron. The pH after the neutralization that exceeds 13 is also not preferred since the hydrolysis of the silane compound added in the silicon oxide coating step as the subsequent step rapidly proceeds, and the coating of the hydrolyzate of the silane compound becomes non-uniform.

In the production method of the present invention, in neutralizing the raw material solution containing the phosphorus-containing ion with an alkali, a method of adding the raw material solution containing the phosphorus-containing ion to an alkali may be employed, in addition to the method of adding an alkali to the raw material solution containing the phosphorus-containing ion.

The value of pH shown in the description herein is measured according to JIS Z8802 with a glass electrode. The value is measured with a pH meter having been calibrated with a suitable buffer solution corresponding to the pH range to be measured. The pH shown in the description herein is a value that is obtained by directly reading the measured value shown by the pH meter compensated with a temperature compensated electrode, under the reaction temperature condition.

The alkali used for the neutralization may be any of a hydroxide of an alkali metal or an alkaline earth metal, aqueous ammonia, and an ammonium salt, such as ammonium hydrogen carbonate, and aqueous ammonia or ammonium hydrogen carbonate, which may leave less impurities at the time when the precipitate of the hydrated oxide of iron is finally converted to the iron oxide through the heat treatment, is preferably used. The alkali may be added in the form of solid to the aqueous solution of the starting substance, and is preferably added in the form of an aqueous solution from the standpoint of the securement of the uniformity in reaction.

After completing the neutralization reaction, the slurry containing the precipitate is retained at that pH for 5 minutes to 24 hours under stirring, so as to age the precipitate.

In the production method of the present invention, the reaction temperature in the neutralization treatment is not particularly defined, and is preferably 10° C. or more and 90° C. or less. The reaction temperature that is less than 10° C. or exceeds 90° C. is not preferred in consideration of the energy cost required for controlling the temperature.

In the second embodiment of the production method of the present invention, an alkali is added to the raw material solution under agitation with a known mechanical means to perform neutralization until the pH thereof reaches 7 or more and 13 or less, so as to form the precipitate of the hydrated oxide of iron, and then in the step of aging the precipitate, the phosphorus-containing ion in an amount of from 0.003 to 0.1 in terms of the molar ratio of P with respect to the molar number of the trivalent Fe ion (P/Fe ratio) is added to the slurry containing the precipitate. The time of addition of the phosphorus-containing ion may be immediately after the formation of the precipitate or during the aging.

The aging time and the reaction temperature of the precipitate in the second embodiment may be the same as those in the first embodiment.

In the third embodiment of the production method of the present invention, an alkali is added to the raw material solution under agitation with a known mechanical means to perform neutralization until the pH thereof reaches 7 or more and 13 or less, so as to form the precipitate of the hydrated oxide of iron, and then the precipitate is aged. The time of addition of the phosphorus-containing ion will be described later.

[Coating with Hydrolyzate of Silane Compound]

In the production method of the present invention, the precipitate of the hydrated oxide of iron formed through the preceding steps is coated with the hydrolyzate of the silane compound. The coating method of the hydrolyzate of the silane compound is preferably a so-called sol-gel method.

In the sol-gel method, a silicon compound having a hydrolyzable group, such as tetraethoxysilane (TEOS) and tetramethoxysilane (TMOS), or a silane compound, such as various silane coupling agents, is added to the slurry of the precipitate of the hydrated oxide of iron to perform hydrolysis reaction under agitation, and the surface of the precipitate of the hydrated oxide of iron is coated with the hydrolyzate of the silane compound thus formed. In the production method of the present invention, the silane compound means an organic silicon compound having a hydrolyzable group. At this time, an acid catalyst or an alkali catalyst may be added, and the catalyst is preferably added in consideration of the treating time. Representative examples of the acid catalyst include hydrochloric acid, and representative examples of the alkali catalyst include ammonia. In the case where an acid catalyst is used, it is necessary that the amount thereof added is limited to such an amount that the precipitate of the hydrated oxide of iron is not dissolved.

Instead of the coating with the hydrolyzate of the silane compound, the coating with sodium silicate (liquid glass), which is an inorganic silicon compound, may be used. The ratio of the total molar number of the trivalent Fe ion charged in the raw material solution and the total molar number of Si contained in the silane compound dripped to the slurry (Si/Fe ratio) is preferably 0.1 or more and 0.3 or less. In the case where the Si/Fe ratio is 0.1 or more, the particles of iron oxide can be prevented from being excessively sintered in the heat treatment. In the case where Si/Fe ratio is 0.3 or less, μ′ can be increased. The Si/Fe ratio is more preferably 0.15 or more and 0.25 or less, and the Si/Fe ratio is further preferably 0.15 or more and 0.21 or less.

The specific procedure for the coating with the hydrolyzate of the silane compound may be the same as in the sol-gel method in a known process. For example, the reaction temperature in the coating with the hydrolyzate of the silane compound by the sol-gel method may be 20° C. or more and 60° C. or less, and the reaction time therefor may be approximately 1 h or more and 20 h or less.

In the third embodiment of the production method of the present invention, the phosphorus-containing ion is simultaneously added to the slurry containing the precipitate of the hydrated oxide of iron obtained through the aging after the neutralization, during the period of from the start of addition of the silane compound to the completion of the addition thereof. The time of addition of the phosphorus-containing ion may be simultaneous with the start of addition of the silane compound, and may be simultaneous with the completion of addition thereof.

[Phosphorus-Containing Ion]

In the production method of the present invention, the phosphorus-containing ion is made to co-exist at the time when the precipitate of the hydrated oxide of iron is coated with the hydrolyzate of the silane compound. The supply source of the phosphorus-containing ion may be phosphoric acid or a soluble phosphate salt (PO₄³⁻), such as ammonium phosphate, sodium phosphate, monohydrogen salts thereof, and dihydrogen salts thereof. Phosphoric acid is a tribasic acid dissociating in three stages in an aqueous solution, and may be in the existing forms of a phosphate ion, a phosphate dihydrogen ion, and a phosphate monohydrogen ion in an aqueous solution. The existing form thereof is determined by the pH of the aqueous solution, but not by the kind of the reagent used as the supply source of the phosphorus-containing ion, and therefore the aforementioned ions containing a phosphoric acid group are generically referred to as a phosphate ion. As the supply source of the phosphorus-containing ion in the present invention, diphosphoric acid (pyrophosphoric acid), which is a condensed phosphoric acid, may also be used. In the present invention, instead of the phosphate ion (PO₄³⁻), a phosphite ion (PO₃³⁻) and a hypophosphite ion (PO₂²⁻) having different oxidation numbers of P may also be used. These oxide ions containing phosphorus (P) are generically referred to as a phosphorus-containing ion.

The amount of the phosphorus-containing ion added to the raw material solution is preferably 0.003 or more and 0.1 or less in terms of the molar ratio with respect to the total molar ratio of Fe contained in the raw material solution (P/Fe ratio). In the case where the P/Fe ratio is less than 0.003, the effect of increasing the average particle diameter of the iron oxide powder contained in the iron oxide powder coated with the silicon oxide may be insufficient, and in the case where the P/Fe ratio exceeds 0.1, the effect of increasing the particle diameter may not be obtained while the mechanism thereof is unclear. The P/Fe ratio is more preferably 0.005 or more and 0.05 or less.

The time of addition of the phosphorus-containing ion to the raw material solution may be any of before the neutralization treatment, after the neutralization treatment and before the coating with the silicon oxide, and during the addition of the silane compound, as described above.

[Recovery of Precipitate]

The precipitate of the hydrated oxide of iron coated with the hydrolyzate of the silane compound is isolated from the slurry obtained through the step of coating with the hydrolyzate of the silane compound. The solid-liquid separation means used may be a known solid-liquid separation means, such as filtration, centrifugal separation, and decantation. In the solid-liquid separation, an aggregating agent may be added for performing the solid-liquid separation.

It is preferred that subsequently the precipitate of the hydrated oxide of iron coated with the hydrolyzate of the silane compound obtained through the solid-liquid separation is washed, and then solid-liquid separation thereof is performed again. The washing method may be a known washing method, such as repulping washing. The precipitate of the hydrated oxide of iron coated with the hydrolyzate of the silane compound thus obtained finally is subjected to a drying treatment. The drying treatment is performed for removing water attached to the precipitate, and may be performed at a temperature of approximately 110° C., which is higher than the boiling point of water.

[Heating Treatment]

In the production method of the present invention, the precipitate of the hydrated oxide of iron coated with the hydrolyzate of the silane compound is subjected to a heat treatment, so as to provide iron oxide powder coated with the silicon oxide as a precursor of the iron powder coated with the silicon oxide. The atmosphere of the heat treatment is not particularly determined, and may be the air atmosphere. The heating may be performed in a range approximately of 500° C. or more and 1,500° C. or less. The heat treatment temperature that is less than 500° C. is not preferred since the particles may not sufficiently grow. The temperature that exceeds 1,500° C. is not preferred since unnecessary growth of the particles and sintering of the particles may occur. The heating time may be controlled to a range of from 10 minutes to 24 hours. The hydrated oxide of iron is changed to the iron oxide through the heat treatment. The heat treatment temperature is preferably 800° C. or more and 1,250° C. or less, and more preferably 900° C. or more and 1,150° C. or less. In the heat treatment, the hydrolyzate of the silane compound covering the precipitate of the hydrated oxide of iron is also changed to the silicon oxide. The silicon oxide coating also has a function preventing the sintering of the precipitate of the hydrated oxide of iron in the heat treatment.

[Reducing Heat Treatment]

In the production method of the present invention, the iron oxide powder coated with a silicon oxide as a precursor obtained in the above described step is subjected to a heat treatment in a reducing atmosphere, so as to provide iron powder coated with the silicon oxide, and the silicon oxide coating of the iron powder coated with the silicon oxide is dissolved and removed in an alkali solution, so as to provide iron powder as the final target product. Examples of the gas forming the reducing atmosphere include hydrogen gas and a mixed gas of hydrogen gas and an inert gas. The temperature of the reducing heat treatment may be in a range of 300° C. or more and 1,000° C. or less. The temperature of the reducing heat treatment that is less than 300° C. is not preferred since the reduction of the iron oxide may be insufficient. With the temperature that exceeds 1,000° C., the effect of reduction may be saturated. The heating time may be controlled to a range of from 10 to 120 minutes.

[Stabilization Treatment]

The iron powder obtained through the reducing heat treatment generally has a surface that is significantly chemically active, and therefore is frequently subjected to a stabilization treatment through gradual oxidation. The iron powder obtained in the production method of the present invention has a surface that is coated with the silicon oxide, which is chemically inert, but there is a case where a part of the surface thereof is not coated, and therefore the stabilization treatment is preferably performed to form an oxidized protective layer on the exposed portion on the surface of the iron powder. Examples of the procedure of the stabilization treatment include the following.

The atmosphere, to which the iron powder coated with the silicon oxide after the reducing heat treatment is exposed, is replaced from the reducing atmosphere to an inert gas atmosphere, and the oxidation reaction of the exposed portion is performed at a temperature of from 20 to 200° C., preferably from 60 to 100° C., while the oxygen concentration in the atmosphere is slowly increased. The inert gas used may be at least one gas component selected from a rare gas and nitrogen gas. The oxygen-containing gas used may be pure oxygen gas and the air. Water vapor may also be introduced along with the oxygen-containing gas. The oxygen concentration, at which the iron powder coated with the silicon oxide is retained at a temperature of from 20 to 200° C., preferably from 60 to 100° C., may be finally from 0.1 to 21% by volume. The introduction of the oxygen-containing gas may be performed continuously or intermittently. In the initial stage of the stabilization step, the period of time when the oxygen concentration is 1.0% by volume or less is preferably kept for 5.0 minutes or more.

[Dissolution Treatment of Silicon Oxide Coating]

In the production method of the present invention, the iron powder coated with the silicon oxide obtained through the preceding steps is immersed in an alkali aqueous solution to dissolve the silicon oxide coating until the Si amount contained in the iron powder reaches 2% by mass or less, so as to provide iron powder.

The alkali aqueous solution used for the dissolution treatment may be an ordinary alkali aqueous solution that is industrially used, such as a sodium hydroxide solution, a potassium hydroxide solution, and aqueous ammonia. The pH of the treatment liquid is preferably 10 or more, and the temperature of the treatment liquid is preferably 30° C. or more and the boiling point or less, in consideration of the treatment time and the like.

The resulting iron powder may be subjected to such operations as washing with water and solid-liquid separation, and then dried.

[Particle Diameter]

The particle diameter of the iron particles constituting the iron powder was obtained by the observation with a scanning electron microscope (SEM).

The observation with SEM was performed, and for one particle, the maximum value of the distance between two straight lines in parallel to each other that hold the particle is designated as the particle diameter of the particle. Specifically, on an SEM micrograph obtained at a magnification of approximately 10,000, 300 particles each having an outer contour, the entire of which was observed in the view field, were randomly selected, the particle diameters of the particles were measured, and the average value thereof was designated as the average particle diameter of the iron powder.

[Axial Ratio]

For one particle on the SEM micrograph, the minimum value of the distance between two straight lines in parallel to each other that hold the particle is designated as the “minor diameter”, and the ratio of (particle diameter)/(minor diameter) is designated as the “axial ratio” of the particle. The “average axial ratio”, which is the axial ratio on an average over the powder, can be determined as follows. In SEM observation, 300 particles randomly selected each are measured for the “particle diameter” and the “minor diameter”, the average value of the particle diameters and the average value of the minor diameters of all the particles as the measurement objects are designated as the “average particle diameter” and the “average minor diameter” respectively, and the ratio (average particle diameter)/(average minor diameter) is designated as the “average axial ratio”. In the measurement of the particle diameter and the minor diameter above, in the case where the number of the particles each having an outer contour, the entire of which was observed in the view field, is less than 300, plural SEM micrographs may be taken for other view fields, and the measurement may be performed until the total number of the particles reaches 300.

[Compositional Analysis]

For the compositional analysis of the iron powder, the contents of Fe and P (% by mass) were measured by the ICP emission spectroscopy after dissolving the iron powder. The Si content (% by mass) of the iron powder was obtained by the silicon quantitative determination method described in JIS M8214-1995.

[Magnetic Characteristics]

The B-H curve was measured with VSM (VSM-P7, produced by Toei Industry Co., Ltd.) under an applied magnetic field of 795.8 kA/m (10 kOe), and the coercive force HC, the saturation magnetization σs, the squareness ratio SQ were evaluated.

[Complex Permeability]

The iron powder and a bisphenol F type epoxy resin (one-component epoxy resin B-1106, produced by Tesk Co., Ltd.) were weighed at a mass ratio of 90/10, and kneaded with a vacuum agitation deaeration mixer (V-mini 300, produced by EME Corporation), so as to provide a paste having the test powder dispersed in the epoxy resin. The paste was dried on a hot plate at 60° C. for 2 hours to provide a composite of the metal powder and the resin, which was then pulverized into particles, which were designated as composite powder. 0.2 g of the composite powder was placed in a toroidal vessel and applied with a load of 9,800 N (1 ton) with a hand press to provide a molded body having a toroidal shape having an outer diameter of 7 mm and an inner diameter of 3 mm. The molded body was measured for the real part μ′ and the imaginary part μ″ of the complex relative permeability with an RF impedance/material analyzer (E4991A, produced by Agilent Technologies, Inc.) and a test fixture (16454A, produced by Agilent Technologies, Inc.), and the loss factor of the complex relative permeability tan δ=μ″/μ′ was obtained. In the description herein, the real part μ′ of the complex relative permeability may be referred to as a “permeability” or “μ′”.

The molded body produced by using the iron powder of the present invention exhibits excellent complex permeability characteristics, and can be favorably used as a magnetic core of an inductor.

[BET Specific Surface Area]

The BET specific surface area was obtained by the BET one-point method with Macsorb model 1210, produced by Mountech Co., Ltd.).

### EXAMPLES

### Example 1

In a 5 L reaction tank, 566.5 g of iron(III) nitrate nanohydrate having a purity of 99.7% by mass and 2.79 g of a 85% by mass H₃PO₄ aqueous solution were dissolved in 4,113.2 g of pure water in the air atmosphere under mechanical agitation with agitation blades, so as to provide a solution (procedure 1). The solution had pH of approximately 1. The molar ratio P/Fe of the amount of P element and the amount of Fe element contained in the solution under the condition was 0.0173.

In the air atmosphere, 409.7 g of a 23.47% by mass ammonia solution was added to the solution under mechanical agitation with agitation blades under a condition of 30° C. over 10 minutes (approximately 40 g/L), and after completing the dripping, the precipitate thus formed was aged by continuing the agitation for 30 minutes. At this time, the slurry containing the precipitate had pH of approximately 9 (procedure 2).

55.18 g of tetraethoxysilane (TEOS) having a purity of 95.0% by mass was dripped to the slurry obtained in the procedure 2 under agitation in the air at 30° C. Thereafter, the agitation was continued for 20 hours, and thereby the precipitate was coated with the hydrolyzate of the silane compound formed through hydrolysis (procedure 3). The molar ratio Si/Fe of the amount of Si element contained in tetraethoxysilane dripped to the slurry and the amount of the trivalent Fe ion contained in the solution under the condition was 0.18.

The slurry obtained in the procedure 3 was filtered, and after draining off water contained in the resulting precipitate coated with the hydrolyzate of the silane compound as much as possible, the precipitate was again dispersed in pure water for repulping washing. The slurry after washing was again filtered, and the resulting cake was dried in the air at 110° C. (procedure 4).

The dried product obtained in the procedure 4 was subjected to a heat treatment in the air at 1,050° C. for 4 hours with a box type baking furnace, so as to provide iron oxide powder coated with the silicon oxide (procedure 5). The production conditions, such as the charge condition of the raw material solution, are shown in Table 1, and the measurement results are shown in Table 2.

5 g of the iron oxide powder coated with the silicon oxide obtained in the procedure 5 was placed in a gas permeable bucket, and a reducing heat treatment was performed by charging the bucket in a through type reducing furnace and retaining at 630° C. for 40 minutes while flowing hydrogen gas in the furnace at a flow rate of 20 NL/min, so as to provide iron powder coated with the silicon oxide (procedure 6).

Subsequently, the atmospheric gas in the furnace was changed from hydrogen to nitrogen, and the temperature in the furnace was decreased to 80° C. at a temperature fall rate of 20° C./min under flowing nitrogen gas. Thereafter, a mixed gas of nitrogen gas and the air at a volume ratio of nitrogen gas/air of 125/1 (oxygen concentration: approximately 0.17% by volume) as the initial gas for performing a stabilization treatment was introduced to the furnace for 10 minutes to initiate the oxidation reaction of the surface layer portion of the iron powder particles, thereafter a mixed gas of nitrogen gas and the air at a volume ratio of nitrogen gas/air of 80/1 (oxygen concentration: approximately 0.26% by volume) was introduced for 10 minutes and a mixed gas of nitrogen gas and the air at a volume ratio of nitrogen gas/air of 50/1 (oxygen concentration: approximately 0.41% by volume) was introduced for 10 minutes, to the furnace, and finally a mixed gas of nitrogen gas and the air at a volume ratio of nitrogen gas/air of 25/1 (oxygen concentration: approximately 0.80% by volume) was continuously introduced to the furnace for 10 minutes, so as to form an oxidized protective layer on the surface layer portion of the particles. In the stabilization treatment, the temperature was retained to 80° C., and the flow rate of the gas introduced was retained to the substantially constant value (procedure 7).

The iron powder coated with the silicon oxide obtained in the procedure 7 was immersed in a 10% by mass sodium hydroxide aqueous solution at 60° C. for 24 hours to dissolve the silicon oxide coating, thereby providing iron powder of Example 1.

The iron powder obtained through the aforementioned series of procedures was measured for the magnetic characteristics, the BET specific surface area, the particle diameter of the iron particles, and the complex permeability, and subjected to the compositional analysis. The measurement results are shown in Table 2.

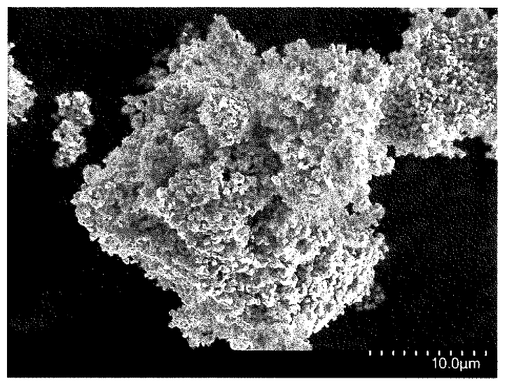

FIG. 1 shows the SEM observation result of the iron powder obtained in Example 1. In FIG. 1, the length shown by the 11 white vertical lines shown in the right lower part of the SEM micrograph is 10.0 μm. The iron powder had an average particle diameter of 0.57 μm, an Si concentration of 0.11% by mass, and μ′ of 8.46.

Since the carbonyl iron powder in Comparative Example 1 described later has an average particle diameter of 0.74 μm and μ′ of 6.38, from which it is understood that the iron powder of the present invention has a smaller average particle diameter and larger μ′ than the ordinary iron powder, and the production method of the present invention can provide iron powder that satisfies both the small particle diameter and large μ′. It is also understood that the molded body produced by using the iron powder of the present invention exhibits excellent complex permeability characteristics, and therefore is favorable as a magnetic core of an inductor.

### Example 2

Iron powder of Example 2 was obtained in the same procedures as in Example 1 except that in the procedure 1 of Example 1 the mass of the 85% by mass H₃PO₄ aqueous solution was changed to 1.39 g. The molar ratio P/Fe of the amount of P element and the amount of Fe element contained in the solution under the condition was 0.0086.

The iron powder of Example 2 was measured for the magnetic characteristics, the BET specific surface area, the particle diameter of the iron particles, and the complex permeability, and subjected to the compositional analysis. The measurement results are shown in Table 2. The iron powder of Example 2 had an average particle diameter of 0.54 μm, an Si concentration of less than 0.1% by mass, which was the detection limit, and μ′ of 8.08.

### Example 3

Iron powder of Example 3 was obtained in the same procedures as in Example 1 except that in the procedure 1 of Example 1 the mass of the 85% by mass H₃PO₄ aqueous solution was changed to 1.63 g, and in the procedure 3 the amount of tetraethoxysilane (TEOS) having a purity of 95.0% by mass dripped was changed to 64.38 g. The molar ratio P/Fe of the amount of P element and the amount of Fe element contained in the solution under the condition was 0.0101, and the molar ratio Si/Fe of the amount of Si element contained in tetraethoxysilane dripped to the slurry and the amount of the trivalent Fe ion contained in the solution under the condition was 0.21.

The iron powder of Example 3 was measured for the magnetic characteristics, the BET specific surface area, the particle diameter of the iron particles, and the complex permeability, and subjected to the compositional analysis. The measurement results are shown in Table 2. The iron powder of Example 3 had an average particle diameter of 0.52 μm, an Si concentration of less than 0.1% by mass, which was the detection limit, and μ′ of 8.07.

### Example 4

Iron powder of Example 4 was obtained in the same procedures as in Example 1 except that in the procedure 1 of Example 1 the mass of the 85% by mass H₃PO₄ aqueous solution was changed to 1.85 g, and in the procedure 3 the amount of tetraethoxysilane (TEOS) having a purity of 95.0% by mass dripped was changed to 73.57 g. The molar ratio P/Fe of the amount of P element and the amount of Fe element contained in the solution under the condition was 0.0115, and the molar ratio Si/Fe of the amount of Si element contained in tetraethoxysilane dripped to the slurry and the amount of the trivalent Fe ion contained in the solution under the condition was 0.24.

The iron powder of Example 4 was measured for the magnetic characteristics, the BET specific surface area, the particle diameter of the iron particles, and the complex permeability, and subjected to the compositional analysis. The measurement results are shown in Table 2. The iron powder of Example 4 had an average particle diameter of 0.53 nm, an Si concentration of 0.16% by mass, and μ′ of 7.66.

### Example 5

Iron powder was obtained in the same procedures as in Example 2 except that the H₃PO₄ aqueous solution was not added to the raw material solution but was added at the time after 10 minutes from the start of aging, and thereafter the aging was performed for 20 minutes.

The iron powder of Example 5 was measured for the magnetic characteristics, the BET specific surface area, the particle diameter of the iron particles, and the complex permeability, and subjected to the compositional analysis. The measurement results are shown in Table 2. The iron powder of Example 5 had an average particle diameter of 0.54 μm, an Si concentration of less than 0.1% by mass, which was the detection limit, and μ′ of 8.04.

### Comparative Example 1

As Comparative Example 1, the magnetic characteristics, the BET specific surface area, and the complex permeability of the commercially available carbonyl iron powder are shown in Table 2. The carbonyl iron powder had a volume cumulative 50% particle diameter of 1.2 μm measured with a laser diffraction particle size distribution measurement device, and μ′ of 6.38.

### Comparative Example 2

Iron powder was obtained in the same procedures as in Example 1 except that the H₃PO₄ aqueous solution was not added to the raw material solution. The magnetic characteristics, the BET specific surface area, the complex permeability, and the result of the compositional analysis of the resulting iron powder are shown in Table 2. The iron powder of Comparative Example 2 had an average particle diameter of 0.06 μm, an Si concentration of less than 0.1% by mass, which was the detection limit, and μ′ of 3.42.

It is understood from the results of Example 2 and Comparative Example 2 that in the case where the phosphate ion is not made to co-exist in the slurry containing the hydrated oxide of iron, the average particle diameter of the iron powder becomes too small as less than 0.25 μm, and thereby μ′ thereof also becomes low.

### Comparative Example 3

Iron powder was obtained in the same procedures as in Example 1 except that in the procedure 1 of Example 1 the mass of the 85% by mass H₃PO₄ aqueous solution was changed to 2.79 g, in the procedure 3 the amount of tetraethoxysilane (TEOS) having a purity of 95.0% by mass dripped was changed to 110.36 g, and in the procedure 5 the temperature of the heat treatment in the air was changed to 1,045° C. The molar ratio P/Fe of the amount of P element and the amount of Fe element contained in the solution under the condition was 0.0173, and the molar ratio Si/Fe of the amount of Si element contained in tetraethoxysilane dripped to the slurry and the amount of the trivalent Fe ion contained in the solution under the condition was 0.36.

The resulting iron powder was measured for the magnetic characteristics, the BET specific surface area, the particle diameter of the iron particles, and the complex permeability, and subjected to the compositional analysis. The measurement results are shown in Table 2. The iron powder of Comparative Example 3 had an average particle diameter of 0.43 μm, an Si concentration of 0.18% by mass, and μ′ of 5.96.

It is understood from the results of Example 1, Example 4, and Comparative Example 3 that in the case where the Si/Fe ratio exceeds 0.3, μ′ is decreased.

### Comparative Example 4

Iron powder was obtained in the same procedures as in Example 2 except that the silicon oxide coating was dissolved by immersing in a 5% by mass sodium hydroxide aqueous solution at 60° C. for 1 hour. The resulting iron powder was measured for the magnetic characteristics, the BET specific surface area, the particle diameter of the iron particles, and the complex permeability, and subjected to the compositional analysis. The measurement results are shown in Table 2. The iron powder of Comparative Example 4 had an average particle diameter of 0.54 μm, an Si concentration of 4.15% by mass, and μ′ of 5.83.

It is understood from the results of Example 2 and Comparative Example 4 that in the case where the Si content of the iron powder exceeds 2.0% by mass, μ′ is decreased.

For reference, the magnetic characteristics, the BET specific surface area, and the complex permeability of the commercially available FeSiCr based atomized powder are shown in Table 2. The FeSiCr based atomized powder had an average particle diameter of approximately 10 μm.

TABLE 1

| | Condition of production of precursor | | | | | | | |
|---|---|---|---|---|---|---|---|---|
| | | | | | Heat | Si dissolution step | | |
| | | | | | treat- | NaOH | Treat- | |
| | Charge | | | | ment | concen- | ment | Agi- |
| | condition of raw | | | | temper- | tration | temper- | tation |
| | material solution | | | | ature | (% by | ature | time |
| | Si/Fe | P/Si | P/Fe | Time of addition of P | (° C.) | mass) | (° C.) | (h) |
| Example 1 | 0.18 | 0.096 | 0.0173 | after charging Fe | 1050 | 10 | 60 | 24 |
| | | | | (before addition of alkali) | | | | |
| Example 2 | 0.18 | 0.048 | 0.0086 | after charging Fe | 1050 | 10 | 60 | 24 |
| | | | | (before addition of alkali) | | | | |
| Example 3 | 0.21 | 0.048 | 0.0101 | after charging Fe | 1050 | 10 | 60 | 24 |
| | | | | (before addition of alkali) | | | | |
| Example 4 | 0.24 | 0.048 | 0.0115 | after charging Fe | 1050 | 10 | 60 | 24 |
| | | | | (before addition of alkali) | | | | |
| Example 5 | 0.18 | 0.048 | 0.0086 | after addition of alkali | 1050 | 10 | 60 | 24 |
| | | | | (before coating silica) | | | | |
| Comparative | carbonyl iron powder | | | | | — | | |
| Example 1 | (commercially available product) | | | | | | | |
| Comparative | 0.18 | 0 | 0 | none | 1050 | 10 | 60 | 24 |
| Example 2 | | | | | | | | |
| Comparative | 0.36 | 0.048 | 0.0173 | after charging Fe | 1045 | 20 | 60 | 24 |
| Example 3 | | | | (before addition of alkali) | | | | |
| Comparative | 0.18 | 0.048 | 0.0086 | after charging Fe | 1050 | 5 | 60 | 1 |
| Example 4 | | | | (before addition of alkali) | | | | |

| | | |
|---|---|---|
| Reference | FeSiCr powder (atomized powder, | |
| Example | commercially available product) | — |

TABLE 2

| | Powder characteristics | | | | iron powder | | | | | | | | | Compound | |
|---|---|---|---|---|---|---|---|---|---|---|---|---|---|---|---|
| | Magnetic characteristics | | | | SEM observation result | | | | | | | | | high | |
| | | Satur- | | | Av- | Vari- | Av- | Vari- | | Vari- | | | | frequency | |
| | Coer- | ation | | BET | erage | ation | erage | ation | | ation | Composition | | | characteristics | |
| | cive | magnet- | | Specific | particle | coef- | minor | coef- | Aver- | coef- | (% by mass) | | | (100 MHz) | |
| | force | ization | | surface | dia- | ficient of | dia- | ficient | age | ficient | | | Weight | Perme- | Mag- |
| | Hc | σs | | area | meter | particle | meter | of minor | axial | of axial | ICP | ICP | method | ability | netic |
| | (kA/m) | (Am²/kg) | SQ | (m²/g) | (μm) | diameter | (μm) | diameter | ratio | ratio | Fe | P | Si | μ′ | loss tanδ |
| Example 1 | 5.4 | 183.9 | 0.039 | 6.63 | 0.57 | 0.30 | 0.43 | 0.28 | 1.34 | 0.15 | 94.50 | 0.11 | 0.11 | 8.46 | 0.054 |
| Example 2 | 6.0 | 186.7 | 0.042 | 9.95 | 0.54 | 0.25 | 0.41 | 0.24 | 1.34 | 0.16 | 94.70 | 0.16 | <0.1 | 8.08 | 0.069 |
| Example 3 | 5.4 | 187.7 | 0.034 | 7.59 | 0.52 | 0.24 | 0.40 | 0.26 | 1.31 | 0.15 | 95.20 | 0.12 | <0.1 | 8.07 | 0.032 |
| Example 4 | 5.6 | 182.5 | 0.037 | 6.50 | 0.53 | 0.32 | 0.41 | 0.31 | 1.30 | 0.16 | 95.70 | 0.17 | 0.16 | 7.66 | 0.033 |
| Example 5 | 6.1 | 183.5 | 0.045 | 7.60 | 0.54 | 0.24 | 0.41 | 0.23 | 1.34 | 0.18 | 93.10 | 0.10 | <0.1 | 8.04 | 0.097 |
| Comparative | 1.1 | 192.4 | 0.005 | 1.98 | 0.74 | 0.46 | 0.68 | 0.47 | 1.11 | 0.13 | — | not | not | 6.38 | 0.021 |
| Example 1 | | | | | | | | | | | | con- | con- | | |
| | | | | | | | | | | | | tained | tained | | |
| Comparative | 39 | 160.4 | 0.262 | 23.90 | 0.06 | 0.03 | 0.04 | 0.26 | | | 89.10 | — | <0.1 | 3.42 | 0.064 |
| Example 2 | | | | | | | | | | | | | | | |
| Comparative | 5.9 | 182.0 | 0.030 | 15.10 | 0.43 | 0.24 | 0.31 | 0.27 | 1.41 | 0.21 | 93.70 | 0.34 | 0.18 | 5.96 | 0.013 |
| Example 3 | | | | | | | | | | | | | | | |
| Comparative | 6.2 | 173.9 | 0.042 | 6.52 | 0.54 | 0.25 | 0.41 | 0.24 | 1.34 | 0.16 | 87.70 | 0.16 | 4.15 | 5.83 | 0.019 |
| Example 4 | | | | | | | | | | | | | | | |
| Reference | 1.3 | 167.0 | 0.010 | 0.12 | approx. | | | | | | | | | 9.23 | 0.174 |
| Example | | | | | 10 | | | | | | | | | | |

1. Iron powder comprising iron particles having an average particle diameter of 0.25 μm or more and 0.70 μm or less and an average axial ratio of 1.5 or less, the iron powder having an Si content of 2% by mass or less based on the mass of the iron powder, and the iron powder providing a molded body obtained through mixing of the iron powder and a bisphenol F type epoxy resin at a mass ratio of 9/1 and compression molding having a real part μ′ of a complex relative permeability measured at 100 MHz of 6.8 or more.

2. The iron powder according to claim 1, wherein the iron powder has a P content of 0.05% by mass or more and 1.0% by mass or less based on the mass of the iron powder.

3. A method for producing the iron powder according to claim 1,
the method comprising:
neutralizing an acidic aqueous solution containing a trivalent Fe ion and a phosphorus-containing ion in an amount of from 0.003 to 0.1 in terms of a molar ratio of P with respect to a molar number of the trivalent Fe ion (P/Fe ratio), with an alkali aqueous solution to provide a slurry of a precipitate of a hydrated oxide of iron;
adding a silane compound in an amount of from 0.1 to 0.3 in terms of a molar ratio of Si with respect to a molar number of Fe contained in the slurry (Si/Fe ratio), to the slurry, so as to coat the precipitate of the hydrated oxide of iron with a hydrolyzate of the silane compound;
recovering the precipitate of the hydrated oxide of iron coated with the hydrolyzate of the silane compound, through solid-liquid separation;
heating the recovered precipitate of the hydrated oxide of iron coated with the hydrolyzate of the silane compound, so as to provide iron oxide powder coated with a silicon oxide;
heating the iron oxide powder coated with a silicon oxide in a reducing atmosphere, so as to reduce the iron oxide powder coated with a silicon oxide to iron powder coated with the silicon oxide; and
immersing the iron powder coated with the silicon oxide in an alkali aqueous solution to dissolve the silicon oxide coating, so as to regulate an Si amount contained in the iron powder to 2% by mass or less.

4. A method for producing the iron powder according to claim 1,
the method comprising:
neutralizing an acidic aqueous solution containing a trivalent Fe ion with an alkali aqueous solution to provide a slurry of a precipitate of a hydrated oxide of iron;
adding a phosphorus-containing ion in an amount of from 0.003 to 0.1 in terms of a molar ratio of P with respect to a molar number of the trivalent Fe ion (P/Fe ratio) to the slurry;
adding a silane compound in an amount of from 0.1 to 0.3 in terms of a molar ratio of Si with respect to a molar number of Fe contained in the slurry (Si/Fe ratio), to the slurry containing the precipitate of the hydrated oxide of iron having the phosphorus-containing ion added, so as to coat the precipitate of the hydrated oxide of iron with a hydrolyzate of the silane compound;
recovering the precipitate of the hydrated oxide of iron coated with the hydrolyzate of the silane compound, through solid-liquid separation;
heating the recovered precipitate of the hydrated oxide of iron coated with the hydrolyzate of the silane compound, so as to provide iron oxide powder coated with a silicon oxide;
heating the iron oxide powder coated with a silicon oxide in a reducing atmosphere, so as to reduce the iron oxide powder coated with a silicon oxide to iron powder coated with the silicon oxide; and
immersing the iron powder coated with the silicon oxide in an alkali aqueous solution to dissolve the silicon oxide coating, so as to regulate an Si amount contained in the iron powder to 2% by mass or less.

5. A method for producing the iron powder according to claim 1,
the method comprising:
neutralizing an acidic aqueous solution containing a trivalent Fe ion with an alkali aqueous solution to provide a slurry of a precipitate of a hydrated oxide of iron;
adding a silane compound in an amount of from 0.1 to 0.3 in terms of a molar ratio of Si with respect to a molar number of Fe contained in the slurry (Si/Fe ratio), to the slurry containing the precipitate of the hydrated oxide of iron, and during a period of from the start of addition of the silane compound to the completion of the addition thereof, further adding a phosphorus-containing ion in an amount of from 0.003 to 0.1 in terms of a molar ratio of P with respect to a molar number of the trivalent Fe ion (P/Fe ratio) to the slurry, so as to coat the precipitate of the hydrated oxide of iron with a hydrolyzate of the silane compound in the presence of the phosphorus-containing ion;
recovering the precipitate of the hydrated oxide of iron coated with the hydrolyzate of the silane compound, through solid-liquid separation;
heating the recovered precipitate of the hydrated oxide of iron coated with the hydrolyzate of the silane compound, so as to provide iron oxide powder coated with a silicon oxide;
heating the iron oxide powder coated with a silicon oxide in a reducing atmosphere, so as to reduce the iron oxide powder coated with a silicon oxide to iron powder coated with the silicon oxide; and
immersing the iron powder coated with the silicon oxide in an alkali aqueous solution to dissolve the silicon oxide coating, so as to regulate an Si amount contained in the iron powder to 2% by mass or less.

6. A molded body for an inductor, comprising the iron powder according to claim 1.

7. An inductor comprising the iron powder according to claim 1.
